(19) United States
(12) Patent Application Publication
(10) Pub. No.: US 2013/0201179 A1
(43) Pub. Date: Aug. 8, 2013

(54) METHOD OF EXTRACTING AND PORTRAYING SEISMIC INFORMATION

(71) Applicant: ROGER YOUNG, Houston, TX (US)

(72) Inventor: ROGER YOUNG, Houston, TX (US)

(21) Appl. No.: 13/367,617

(22) Filed: Feb. 7, 2012

(51) Int. Cl. G06T 15/00; G06T 11/20

(52) U.S. Cl. 345/419; 345/440

(57) ABSTRACT

A method of seismic analysis is utilized to produce a display by extracting one or more horizons, where each of the horizons are defined by a plurality of data points. A computer may be programmed to select a plurality of computation points on each the horizons. The information in at least a portion of the first group of data points and the second group of the data points is combined to produce a plurality of combination points. The plurality of combination points may be utilized to produce combination point mappings, which are displayed.

### BACKGROUND OF THE INVENTION

1. Field of the Invention

The present invention relates generally to seismic signal processing and, more particularly, to apparatus and methods to visualize attributes of formations of interest.

2. Description of the Background

Geophysical and geologic study of the subsurface structure of the earth continues to be an important field of endeavor for several reasons. The continued search for producing reservoirs of hydrocarbons, such as oil and gas, is a particularly important motivation for obtaining improved information about the earth's subsurface.

Seismic data is produced in response to a seismic source which generates sound waves that reflect from subsurface formations. The sound waves are detected by a geophone array and recorded. Seismic data is acquired with a geometry that results in the same subsurface points being sampled by numerous source to receiver pairs with different angular relationships, e.g., return energy is measured at surface receiver locations at varying distances and azimuths from the source location. The travel time of energy from source to receiver, via reflections and refraction from interfaces of subsurface strata is indicative of the depth and orientation of the subsurface strata.

The detected wave-like signals have phases that include peaks, troughs, and zero-crossings that are sometimes utilized in picking or extracting what are referred to as horizons. The horizons provide evidence of surfaces of relatively constant geologic time. In a geologic time volume, sediment was deposited, which now corresponds to a travel time (or depth) of sample points of a volume of seismic data. If a constant geologic time can be detected, then the horizon or surface of constant geologic time can be displayed.

There are many computer programs that detect horizons. For example, a “horizon picker” program may follow a selected phase (e.g. peak, trough, zero-crossing) of adjacent seismic traces to form a horizon that may be displayed in two or three dimensions. These displays may be utilized to show various subsurface features such as pinchouts, angularities and the interference of events with different dip attitudes.

One problem with such programs is that seismic traces often become washed out, flattened, encounter complex fractured formations, faults, or the like, to the point that the program cannot follow along the same time horizon. In such cases, the program selects a path of the horizon in the midst of the signals, depending on the particular computer programming, and also depending on factors such as the starting point from which the data is processed. In review of the horizons selected by the programming, it may become clear to a user that the displayed horizons are incorrect or inconsistent. In fact, the same program may pick a different horizon depending on the starting point or the direction of the computation. Thus, horizon picking programs have inaccuracies that sometimes produce a lack of clarity.

The following patents describe efforts to provide programs that may be utilized to pick, extract, and/or utilize horizons.

U.S. Pat. No. 6,708,118, to T. J. Stark, issued Mar. 16, 2004, discloses a system for utilizing a geologic time volume to investigate a portion of the earth in which a geologic time is selected and a search is made in the geologic time volume for locations having substantially the selected geologic time. Locations in the geologic time volume having substantially the geologic time are extracted from the geologic time volume. Locations having substantially the selected geologic time may be displayed to facilitate use of the geologic time volume by an interpreter.

U.S. Pat. No. 6,853,922, to T. J. Stark, issued Feb. 8, 2005, discloses a system for analyzing seismic data which includes selecting a geologic time volume for a subsurface region of interest and selecting a procedure for generating a derived data volume based on the geologic time volume. The selected procedure is used to calculate the derived data volume and the derived data volume is stored in a data storage medium. In specific embodiments of the invention, the derived data volumes include but are not limited to difference volumes, discontinuity volumes, fault volumes, unconformity volumes, throw volumes, heave volumes, dip magnitude volumes, dip azimuth volumes, strike volumes, surface normal volumes, closure volumes, spill point volumes, isopach volumes and isopach anomaly volumes.

U.S. Pat. No. 5,920,828, to Norris et al., issued Jul. 6, 1999, discloses an automated quality control system for processing geophysical seismic data and positioning data from a marine navigation system. The invention includes a prospect data logger in communication with system components for accessing the seismic data, for coordinating seismic data processing, and for identifying and storing attribute data relevant to the seismic data and the positioning data. The prospect data logger is capable of storing data in a programmed format, and can be engaged with a display for illustrating data accessible to the prospect data logger. The prospect data logger is capable of automatically performing quality control functions such as checking seismic data and positioning data, of verifying the format of merged seismic and positioning data, of generating a command for indicating an event or for controlling another system component. The prospect data logger can verify storage tape quality immediately after data is inputted, and a record of events can be generated. Raw seismic data and positioning data is contemporaneously merged, the merged data can be monitored on a real-time basis, and data processing and quality control can be performed from remote terminals. The system uniquely provides real-time quality control operations sufficient to identify variables and events so that immediate system corrections can be made.

U.S. Pat. No. 6,850,845, to T. J. Stark, issued Feb. 1, 2005, discloses a method for analyzing seismic data in which a seismic data volume, which includes seismic data sample points, is selected from a subsurface region of interest. A geologic time volume is declared having data storage locations corresponding to the seismic data sample points. Geologic times are obtained corresponding to the seismic data sample points, and the geologic times are stored in the geologic time volume in data storage locations corresponding to the seismic data sample points.

U.S. Pat. No. 6,853,922, to T. J. Stark, issued Feb. 8, 2005, discloses a system for analyzing seismic data which includes selecting a geologic time volume for a subsurface region of interest and selecting a procedure for generating a derived data volume based on the geologic time volume. The selected procedure is used to calculate the derived data volume and the derived data volume is stored in a data storage medium. In specific embodiments of the invention, the derived data volumes include but are not limited to difference volumes, discontinuity volumes, fault volumes, unconformity volumes, throw volumes, heave volumes, dip magnitude volumes, dip azimuth volumes, strike volumes, surface normal volumes, closure volumes, spill point volumes, isopach volumes and isopach anomaly volumes.

A long felt need continues to exist, however, for improved systems for organizing, storing and displaying seismic information to assist in the analysis and interpretation of the subsurface structure and geology.

### SUMMARY OF THE INVENTION

It is an object of the present invention to provide an improved seismic analysis method which may be applied to 1-D, 2-D, 3-D, or 4-D data.

It is yet another object of the present invention to provide an improved method for classifying and/or displaying seismic data.

It is yes another object of the present invention to provide displays that are improved as compared to convention displays of horizons produced by conventional horizon pickers.

These and other objects, features, and advantages of the present invention will become apparent from the drawings, the descriptions given herein, and the appended claims. However, it will be understood that above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

The present invention comprises a method for analyzing and/or displaying seismic data.

According, in one embodiment, a method for producing a display from seismic data stored on a computer storage medium may comprise one or more steps such as, for example, extracting at least one horizon from the seismic data wherein the horizon is defined by a plurality of data points. Various conventional methods may be utilized to produce the horizons.

Other steps may comprise selecting a plurality of computation points on the horizon whereby a plurality of data points is provided which surround corresponding of the plurality of computation points. For a two dimensional horizon, the points may be on either side of the computation points. For a three dimensional horizon, the points may surround the computation points in 3 dimensions.

Additional steps may comprise combining information in the plurality of data points for each of the computation points to produce a plurality of combination points, combining the combination points to provide at least one combination point mapping, and producing a display of the combination point mapping. Combination point mappings can appear similar to horizons but have quite different features that are valuable. For example, for the same block of data combination point mappings can appear clearer, and are much less susceptible to washed out regions that horizons.

In one embodiment, the information to be combined from the plurality of data points consists of depth or time (z-axis information) information so the depth of the combination point is different from the depth of the computation point but the range (x and/or y information) is the same.

In one embodiment, the plurality of data points may comprise a first group of data points and a second group of the data points for each of the computation points wherein the first group of data points is on an opposite side from the second group of data points for each of the plurality of combination points.

In one embodiment, the depth resolution of the combination point mapping is selectively different than a depth resolution of the seismic data stored on the computer storage medium. For example, the depth resolution of the combination point mapping may be selectively greater than or less than a depth resolution of the seismic data stored on the computer storage medium.

In one embodiment, the first total number of data points in plurality of data points, or in groups of data points around the computation point, can change with different computation points.

In one embodiment, the method may further comprise utilizing only a first group of data points and a second group of data points on opposite sides of a computation point to produce a two dimensional display.

In another embodiment, the method may further comprise utilizing the plurality of data points surrounding each computation point to produce a three dimensional display.

In another embodiment, a method is provided for displaying seismic data stored on a computer storage medium utilizing a programmed computer. In this embodiment the method comprise one or more steps, such as for example, programming the computer to extract at least one horizon from the seismic data.

Other steps may comprise programming the computer to select a plurality of computation points on the horizon whereby a plurality of data points is provided on different sides of the computation points and programming the computer to combine information in the plurality of data points for the computation points to produce a plurality of combination points, programming the computer to utilize the plurality of combination points to produce at least one combination point mapping, and programming the computer to display the at least one combination point mapping.

The plurality of data points may comprise various data points such as, for example, a first group of data points provided on one side of each or most of the computation points and a second group of data points provided on a different side of each or most of the computation points.

In one embodiment, the combined information consists of only depth or time information so that the combination point is mapped to a different time depth (z-axis) as a computation point but the same range (x and/or y position).

In another embodiment, the method may comprise one or more steps such as, for instance, a step of obtaining seismic data produced in response to acoustic signals transmitted through the earth.

### BRIEF DESCRIPTION OF THE DRAWINGS

FIG. 1 is a plot displaying a single horizon which comprises a plurality of data points and a subsequently produced combination point mapping for display comprising combination points computed from selected computation points and at least of portion of information in data points surrounding each computation in accord with one possible embodiment of the present invention.

FIG. 2 is a plot of showing two combination point mappings which illustrates different rates of deposit of sediment which produced underground formations in accord with one possible embodiment of the present invention.

FIG. 3 is a display of horizon mappings in accord with one possible embodiment of the present invention;

FIG. 4 is a display of horizon mapping which includes the mapping data of FIG. 3 and additional horizon mapping whereby the horizon mappings are shown to have changed due to the increased data processed in accord with one possible embodiment of the present invention;

FIG. 5 is a three dimensional display of a combination point mapping in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE PREFERRED EMBODIMENTS

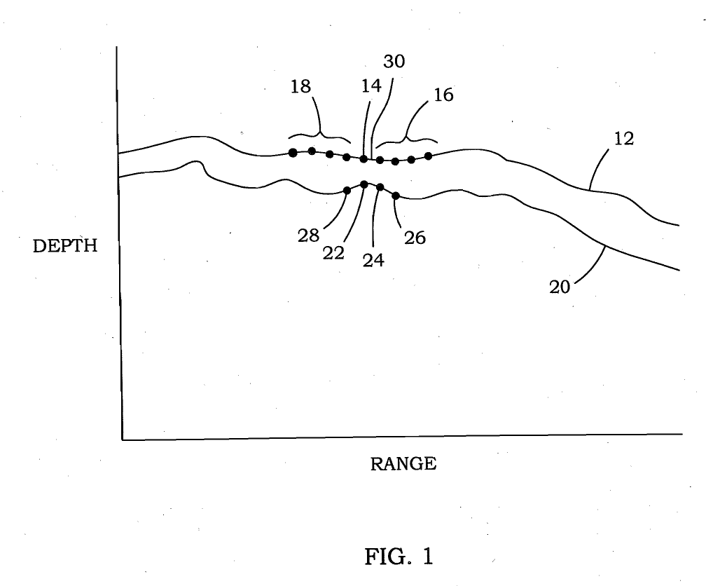

FIG. 1 shows, for clarity of explanation, a single two dimensional horizon 12, which may be produced from a seismic data section utilizing a conventional horizon picker, which as discussed hereinbefore, are well known in the art. FIG. 1 is shown in two dimensions although the invention described herein is applicable to three dimensional (3D) seismic data (or four dimensional) as well as to two dimensional (2D) seismic data. It will be understood that normally many horizons may be produced in layers for convenience of explanation only one horizon is shown. The displayed horizons are limited in resolution to the resolution or sample rate of the seismic data.

Although the horizon shown in FIG. 1 appears continuous, those of ordinary skill in the art will recognize that each seismic data trace is recorded by sampling the reflected seismic energy waves at discrete sample times with respect to depth (in this case the z-axis or vertical axis of FIG. 1), which produce a resolution of the seismic data, at intervals typically ranging from 1 to 4 milliseconds. The x-axis or y-axis (in this case the horizontal or range axis) represents the slice of earth being analyzed an the bottom of FIG. 1. Although the following generally describes the procedure in relationship to data in two way travel time, the procedures described herein are equally valid for seismic data which have been converted to depth and/or geological times.

The invention will be described herein primarily with reference to a 3D seismic data volume. Each seismic data volume comprises x, y and z data points (where x and y represent the in-line and cross line directions, and z represents the travel time or depth). As one possible typical example, the seismic data volume might comprise 2000 cross lines and 2000 in-lines and extend for a depth of greater than 3000 time samples, for a total of 12 billion (12,000,000,000 or 12×10⁹) data sample points. It will be understood that considerably more or few data sample points may be utilized. It will also be understood that the invention is applicable to other coordinate systems so that discussions of the types of coordinates is interchangeable with other coordinate systems.

It may also be desirable, in accord with the present invention, to produce a sectional view or slice of the earth which shows lithology and fluids within the lithology. If desired, it may also be desirable to color traces in a gather related to time or depth samples utilizing a color scheme in accord with the present invention. The traces may also be colored with respect to derivatives or changes or ranges of change.

The invention may be applied to information extracted from any variety of gathers from seismic data including, but not limited to, common-midpoint, common data point, shot domain, receiver domain, and/or other conceivable types of gathers. The seismic data may or may not have been migrated and may typically be represented in time or depth.

In FIG. 1, horizon 12, as generated by a conventional horizon picker program, comprises a plurality of data points, such as data point 14, data point group 16, and data point group 18. As noted above, horizon 12 can be produced by many different horizon picker or horizon extraction computer programs. The invention is not limited to any particular type of horizon picker or horizon extraction computer program but instead can be used with any conventional horizon extraction program.

As discussed hereinbefore, as a general rule horizon pickers typically attempt to follow a selected phase of the seismic signals for a particular depth or time (or age) to produce the horizon. As also discussed hereinbefore, many types of down hole formations will be problematic for the horizon picker program to follow the same depth or time surface or phase of the signals.

Data point group 16, on horizon 12, preferably but not necessarily includes all data points to the right of data point 14 and data point group 18 preferably but not necessarily includes all data points to the left of data point 14. Data point 14 could be any data point on horizon 12. However, the same computation or the concept of computation can be applied to each data point on horizon 12.

In this example of the invention, data point group 16 includes all data points to the right of data point 14 and data point group 18 includes all data points to the left of data point 14. In another example data point group 16 and/or data point group 18 may comprise 20, 30, 50, 100, 200, 1000 or more data points, or any fewer or in between number of data points. At the left end and right end of the data, the number of points in data point groups 16 and 18 may differ. If all data points are utilized, then the number of points in data point groups 16 and 18 may change at each computation point. In another embodiment, such as a moving average, data point groups 16 and 18 comprise the same number of data points for many computations.

In accord with the present invention, the computer is programmed to map or compute or extract what is referred to herein as a combination point mapping 20 utilizing the data points on horizon 12, which are combined to produce combination point mapping 20. Thus, by combining all or a selected number of the data points on horizon 12, combination point mapping 20 is produced.

In one embodiment, the method of combining data points from horizon 12 to produce combination point mapping 20 involves averaging the depth information of groups of points 16 and 18 to the right and left of data point 14, to produce combination point 22. Therefore, the mapping of combination point 22 will involve plotting a point at typically a different depth (due to the averaging of groups of points 16 and 18) but the same range (x and/or y position). In other words, combination point 22 has depth information that is the combination of the depth information in groups 16 and 18 but at the same range.

Averaging processes may comprises a moving average, weighted average, exponential average or the like may be applied starting from data point 14, and going in the left direction and the right direction. Other methods may comprise producing integrals, derivatives, or other mathematical functions which operate on the data points to the right and left of the starting point on the horizon, which computations are then mapped for each desired computation point on the horizon to produce a combination point mapping. In other words, the result of the averaging or other combinational method, starting at data point 14 is mapped onto combination point mapping 20 at what may be referred to herein as combination point 22.

The mapping may continue by moving to the next data point to the right of point 14, running the average again and producing combination point 24. The same process occurs to produce combination point 26.

To produce combination point 28 to the left of combination point 22, the next data point to the left of data point 14 can be utilized as the starting point of the averaging or combination method. Thus, the method of producing a plurality of combination point mapping 20 comprises selecting a plurality of computation points on each of said plurality of horizons.

In this example, computation is made at each data point, such as data point 14, on horizon 12. Thus, data point 14 may also be referred to herein as a computation point. However, the computation might be made at every other data point so that all data points are not also computation points where at each computation point, as discussed above, an averaging process is made. In general, however, data points and computation points are considered interchangeable but it will be appreciated that they may be produced in different ways and/or selected in different ways. For example, a computation point may be made in between the data points. For example computation point 30 may be utilized as the starting point for averaging, whereby two combination points, or any selected number of combination points, may be made for each data point. The value at the computation point may be derived, such as by projecting or averaging adjacent points. If more than one computation point occurs between data points, then the values may be extracted by the distance and values of the adjacent data points.

In the direction of time or depth or formation age (z-axis), the present invention allows the unique possibility of producing combination point mappings with a resolution of 1 millisecond per sample from 4 millisecond/sample originally recorded data. In other words, the combination point mappings, such as computation points 22, 24, 26, and 28 may be produced at higher resolutions than the resolution at which the data was originally recorded. This possibility arises because the averaging methods will produce computation depths or times which fall outside of the particular sample rates. Accordingly, the present invention produces combination point mappings 20 at any selectable resolution, which is larger or smaller than the recorded resolution of the original data.

Accordingly, at least a portion of said plurality data points for each of said computation points on each of said plurality of horizons are used produce a plurality of combination points, which are utilized to plot a combination point mapping, such as combination point mapping 20. A display is then produced to display a desired combination point mapping or, more typically, a plurality of combination point mappings. A computer program is utilized to make the computations and produce the display.

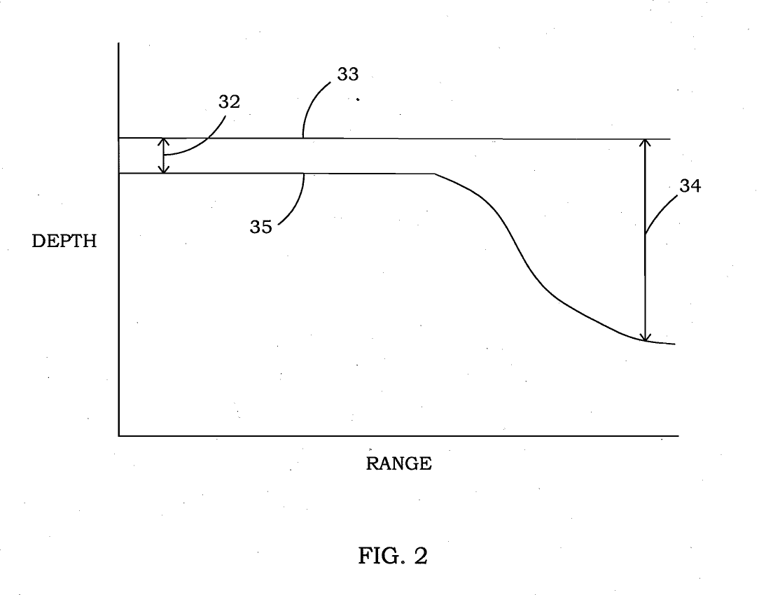

The combination point mappings may be utilized in ways that are often used to analyze conventional horizon picker displays. However, in some cases, the results are often enhanced with a greater clarity. FIG. 2 shows two combination point mappings 33 and 35. In one method of analysis, the difference 32 and 34 between the two combination point mappings is shown, which represents different rates of deposition which occurred as the formations were being formed. The difference 32 may comprise a faster rate of deposition than shown at difference 34, which may be of interest to geologists, who are attempting to determine the structure and/or content of the underlying geological formations.

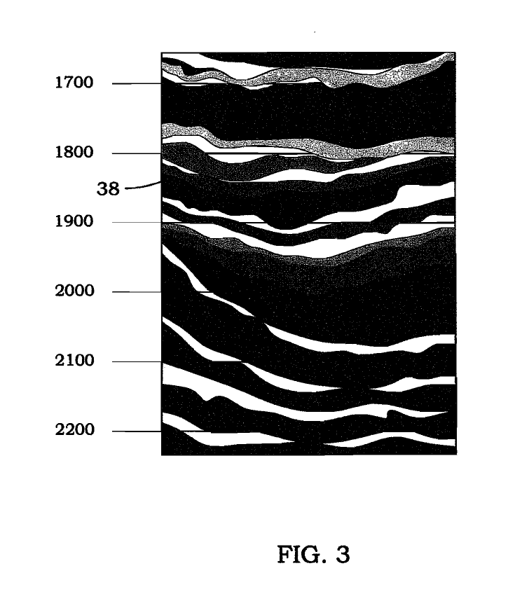

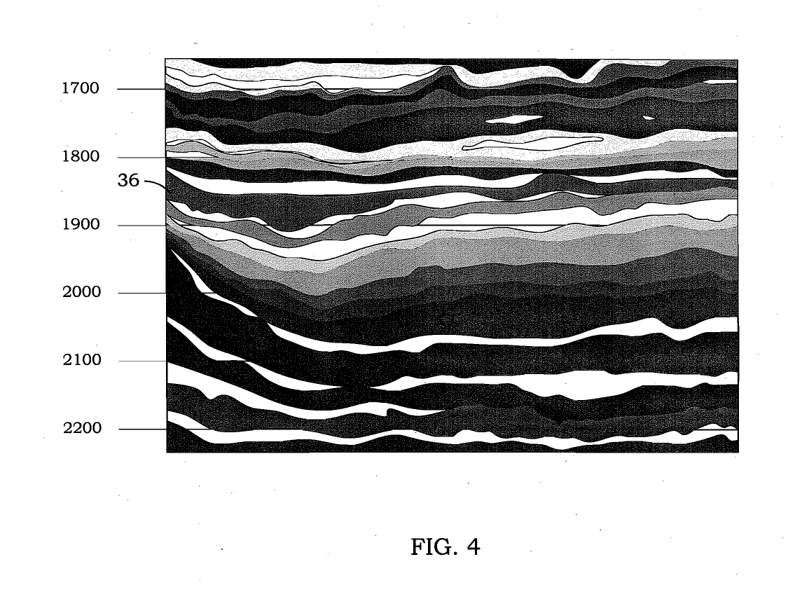

FIGS. 3 and 4 illustrate some display features of combination point mappings as compared to horizon picker displays. As previously discussed, horizon picker displays will often vary depending on the starting point from which the horizon picker program begins. In other words, a display of the same data may appear quite different if the starting point of the horizon picker begins at different starting points, because branches or discontinuities may be processed differently resulting in quite different results. However, for the same set of data, the combination point mappings will be the same regardless of the starting point.

On the other hand, for computation point mappings, the display will typically change depending on the volume or amount of data processed. For example, in FIG. 3 less data is available for processing to produce computation point mappings than is available for FIG. 4. Recalling that the computation point mappings produce points that are contingent on the data to the right and left of the points selected from the horizons, it will be appreciated that as points are added or reduced from the right or left, then the computation point mappings will change. This feature of change depending on the volume of data processed can be seen when comparing computation point mappings at, for example, computation point mappings 38 and 36 in FIG. 3 and FIG. 4, respectfully.

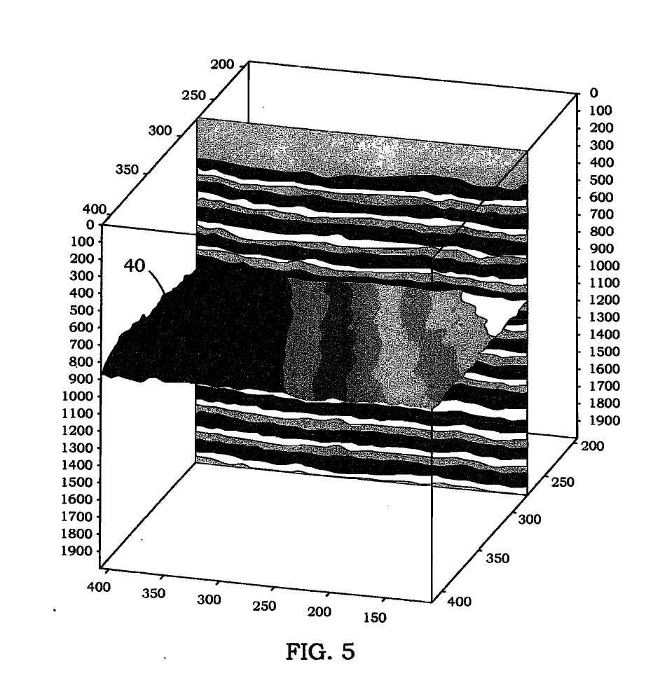

FIG. 5 shows an example of a three dimensional computation point mapping surface 40. In this example, horizon surfaces are produced, computation points are selected, and then data points in x and y directions (or in another two directions as desired) are selected for combination (some examples of which are discussed above) and then mapped into another surface, which may be referred to herein as a combination point mapping surface 40. In another embodiment, a plurality of two dimensional horizons, at the approximate same depth may be processed as discussed above and combined in three dimensions to form computation point mapping surface 40. Accordingly, the three dimensional computation point mapping surfaces may be produced in different ways than the two dimensional point mappings discussed above. As another possibility, three dimensional point mapping surfaces 40 may be formed and then sliced to produce two dimensional point mappings.

Accordingly, the foregoing disclosure and description of the invention is illustrative and explanatory thereof, and it will appreciated by those skilled in the art, that various changes in the ordering of steps, ranges, and/or attributes and parameters, as well as in the details of the illustrations or combinations of features of the method of seismic analysis may be made without departing from the spirit of the invention.

What is claimed is:

1. A method for producing a display from seismic data stored on a computer storage medium, comprising:
extracting at least one horizon from said seismic data, said at least one horizon being defined by a plurality of data points;
selecting a plurality of computation points on said at least one horizon whereby a plurality of data points is provided which surround corresponding of said plurality of computation points; and
combining information in said plurality of data points for each of said computation points on said at least one horizon to produce a plurality of combination points;
combining said combination points to provide at least one combination point mapping; and
producing a display of said at least one combination point mapping.

2. The method of claim 1 wherein said plurality of data points comprise a first group of data points and a second group of said data points for each of said computation points wherein said first group of data points is on an opposite side from said second group of data points for each of said plurality of combination points.

3. The method of claim 1 wherein said information to be combined consists of depth or time information.

4. The method of claim 3 wherein a depth resolution of said at least one combination point mapping is selectively different than a depth resolution of said seismic data stored on said computer storage medium.

5. The method of claim 3 wherein a depth resolution of said at least one combination point mapping is selectively greater than a depth resolution of said seismic data stored on said computer storage medium.

6. The method of claim 3 wherein for each combination point there is a computation point which has a range which is the same.

7. The method of claim 2 wherein for each computation utilized a depth or time for each computation point is produced based on depth or time information of said first group of data points and said second group of said data points.

8. The method of claim 2 where a first total number of data points in said first group of data points and a second total number of data points in said second group of data points changes with different computation points.

9. The method of claim 2 further comprising utilizing only said first group of data points and said second group of data points to produce a two dimensional display.

10. The method of claim 1 further comprising utilizing said plurality of data points surrounding each computation point to produce a three dimensional display.

11. A method for displaying seismic data stored on a computer storage medium utilizing a programmed computer, comprising:
programming said computer to extract at least one horizon from said seismic data, said at least one horizon being defined by a plurality of data points;
programming said computer to select a plurality of computation points on said at least one horizon whereby a plurality of data points is provided on different sides of each of said computation points; and
programming said computer to combine information in said plurality of data points for each of said computation points on said at least one horizon to produce a plurality of combination points;
programming said computer to utilize said plurality of combination points to produce at least one combination point mapping; and
programming said computer to display said at least one combination point mapping.

12. The method of claim 11 wherein said plurality of data points comprises a first group of data points provided on one side of each of said computation points and a second group of data points provided on a different side of each of said computation points.

13. The method of claim 12 wherein said combined information in said first group of data points and said second group of said data points consists of only depth or time information.

14. The method of claim 12 wherein each computation point is produced based on depth or time information of said first group of data points and said second group of said data points.

15. The method of claim 11 wherein each combination point produced has a range which is the same for a corresponding computation point.

16. The method of claim 12 where said computer is programmed to utilize a first number of data points in said first group of data points and a second number of data points in said second group of data points, wherein said first number of data points and said second number of data points changes with different computation points.

17. The method of claim 12 further comprising utilizing only said first group of data points and said second group of data points to produce a two dimensional display.

18. The method of claim 11 further comprising utilizing said plurality of data points surrounding each computation point to produce a three dimensional display.
